(19) United States
(12) Patent Application Publication
(10) Pub. No.: US 2017/0337689 A1
(43) Pub. Date: Nov. 23, 2017

(54) METHOD FOR VALIDATING SEGMENTATION OF OBJECTS WITH ARBITRARY SHAPES

(71) Applicant: Yung-Hui Li, Taichung City (TW)

(72) Inventor: Yung-Hui Li, Taichung City (TW)

(21) Appl. No.: 15/160,838

(22) Filed: May 20, 2016

(51) Int. Cl. G06T 7/10; G06K 9/00; G06T 7/11; G06T 7/33

(52) U.S. Cl. CPC G06T 7/10; G06T 7/33; G06K 9/0061; G06T 7/11; G06T 2207/20116

(57) ABSTRACT

A method for validating segmentation of an object includes the following steps: processing an image of the object to enhance contour characteristics of the object and reduce external interference; setting a presumptive segmentation contour according to a characteristic equation and setting an inner boundary and an outer boundary for the presumptive segmentation contour to define an area; and setting a predetermined number of pairs of points and accumulating differences of the pairs of points to judge the correctness of segmentation of the object. Each pair of points includes a first sample point on the outer boundary and a second sample point on the inner boundary.

### TECHNICAL FIELD

Aspects of the invention relate generally to a judgment mechanism, and more particularly to a correctness judgment mechanism for the segmentation of objects with arbitrary shapes.

### BACKGROUND

Biometrics recognition, which identifies individuals in groups using distinctive human characteristics, has attracted increasing interests from various communities for several years and has also been widely integrated into commercial products. Face recognition and fingerprint recognition, for instance, are the two representative applications of biometrics recognition. However, the two applications suffer from certain constraints. For example, fingerprints are easily forged, and they are liable to be damaged by environmental factors since fingers often touch external environment. Besides, facial features have low inter-class variation and are easily affected by environmental factors. In contrast, iris recognition has low inter-class variation and may accurately detect human characteristics. Besides, iris recognition is not easily affected by environmental factors, has comparatively higher recognition accuracy, and is realized without the need of physical contact. Accordingly, iris recognition is becoming more widely utilized nowadays.

### SUMMARY

The key issue about iris segmentation is how to obtain a correct sampling position of an iris. Therefore, correct segmentation positions may contribute to a variety of applications for the iris biometrics recognition.

According to one aspect of the present disclosure, a method for validating segmentation of an object includes the following steps: (1) processing an image of the object to enhance contour characteristics of the object and reduce external interference; (2) setting a presumptive segmentation contour according to a characteristic equation and setting an inner boundary and an outer boundary for the presumptive segmentation contour to define an area, wherein the inner boundary is formed by inwardly shifting points on the presumptive segmentation contour for a preset distance according to the characteristic equation, and the outer boundary is formed by outwardly shifting points on the presumptive segmentation contour for a preset distance according to the characteristic equation; and (3) setting a predetermined number of pairs of points and accumulating differences of the pairs of points to judge the correctness of segmentation of the object, where each pair of points comprise a first sample point on the outer boundary and a second sample point on the inner boundary.

According to the above embodiment, the judgment mechanism is realized by a segmentation algorithm that calculates characteristic parameters of an image to determine the correctness of iris segmentation without human intervention. This improves recognition speed, minimize amount of manual labor, and enhance recognition stability and reliability.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows an exemplary iris image according to an embodiment of the invention.

FIG. 2 shows a schematic diagram illustrating an accumulation difference according to an embodiment of the invention.

Corresponding reference characters indicate corresponding parts throughout the drawings.

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

Embodiments of the invention relate to validation of iris segmentation, where correct iris segmentation is obtained to allow for succeeding recognition of iris characteristics. A segmentation contour of an eye may be divided into a pupil inner circle and an iris outer circle. Though the segmentation contour is exemplified as a circle, it may have other shape such as an ellipses contour or a free-form contour. The validation procedure for the iris segmentation is described below.

1. Image Processing

Images of an eye are subject to a procession to enhance contour characteristics and thus reduce external interference such as mirror reflections or existence of eyelashes and eyelids. Typically, K-means algorithm and principal component analysis (PCA) may be applied to the image procession. K-means algorithm is a clustering algorithm commonly used in machine learning and data mining. The goal of K-means is to separate samples into a preset number of clusters according to the respective distance of each cluster relative to the center position of recursion. According to the K-means algorithm, an image is defined as a preset number of clusters K, and positions of K points μ₁₋μ_{K} in a parameter space are randomly initialized to form K clusters. Each of the samples x₁, . . . , x_{N} (suppose there are N samples in a image) is assigned to a cluster whose center is derived by following equation:

arg min _{1≦i≦k}||xⱼ−μᵢ||², xⱼ∈{x₁, . . . , x_{N}},
all centers of clusters can be updated using the following equation:

$${μ}_{i} = \frac{{\sum }_{X ∈ si}^{ } x}{\vert Sk \vert} , 1 \leq i \leq k ,$$

and calculations using the above two equations are iterated until all centers of clusters become stable. The stable state can be determined according to the following equation:

$$\frac{{\sum }_{1 \leq i \leq k} {\sum }_{{x}_{j} ∈ {s}_{i}} {‖ {x}_{j} - {μ}_{i} ‖}^{2}}{\vert n \vert} < ɛ ,$$

where ε is a given threshold.

The main disadvantage of K-means algorithm is that wrong initialization of centroids would cause incorrect clustering results. To resolve this problem, the PCA technique is used to extract the principle components from the results produced by K-means algorithm.

Data produced by K-means algorithm may be converted by PCA into a set of linearly uncorrelated variables. PCA is an algorithm to extract principal components based on high dimensional statistics. Therefore, data in a sample space may be transformed into multi-dimensional coordinates in an orthogonal PCA subspace. During the conversion, one may first extract a local 3×3 window around 10 cluster centers (9-dimensional) as training data to construct a PCA subspace. The PCA subspace may include 9 eigenvectors (9-dimensional) which are the principal components of the 10 cluster centers. Then, those 9 eigenvectors are sorted with their importance (according to their corresponding eigenvalues) and placed as column vectors V. Finally, one may project the original centers μ1, μ2, . . . , μk to the PCA subspace using the following equation:

$${μ}_{i}^{′} = {V}^{T} ( {μ}_{i} - \frac{{\sum }_{j = 1}^{k} {μ}_{j}}{k} ) , 1 \leq i \leq k ,$$

where V^{T} denotes the transpose of V, and then one may also project each data point into the same coordinate system by the following equation:

$${x}_{i}^{′} = {V}^{T} ( {x}_{i} - \frac{{\sum }_{j = 1}^{k} {μ}_{j}}{k} ) , {x}_{i} ∈ \{ {x}_{1} , … , {x}_{n} \} ,$$

where xi is a pixel value of the local 3×3 window (9-dimension) in an eye image. All values of xi′ are grouped into a new cluster whose center is derived by the following equation:

arg min_{1≦i≦k}||xᵢ′−μᵢ′||², xⱼ∈{x₁′, . . . , xₙ′}.

Finally, each pixel intensity value is replaced with a coefficient of its cluster center's first component, and each pixel intensity value is represented as a value in the range of {0, 255} to generate a smooth PCA image. This may make the center of the clusters more representative and widen the variance between nine clusters. Compared with an image processed solely by the K-means algorithm, the PCA processing may enhance the stability of the smoothed image.

2. Contour Recognition

First, a presumptive segmentation contour to be recognized is set. In this embodiment, a segmentation contour of an iris to be recognized is divided into a pupil inner circle and an iris outer circle. Then, a contour characteristic equation is applied, where an inner boundary and an outer boundary are respectively set according to an inner preset shift and an outer preset shift to define an area between the inner boundary and an outer boundary.

3. Sampling Points

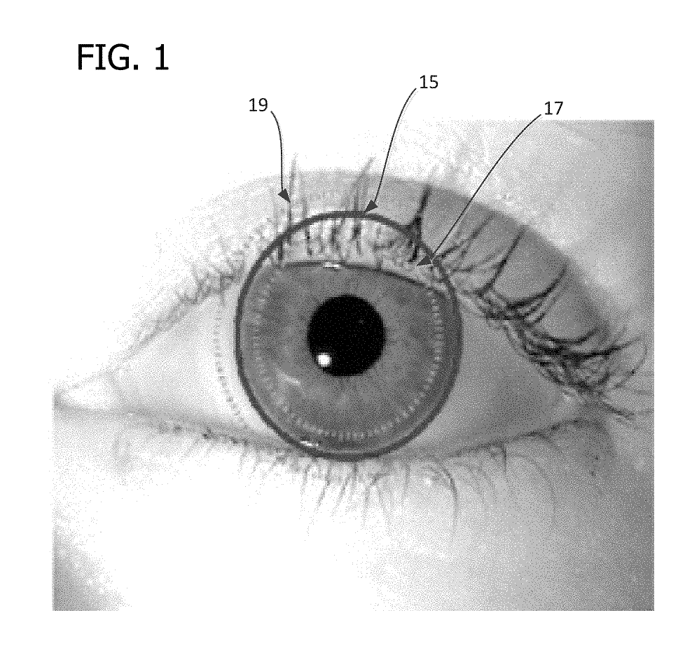

FIG. 1 shows an exemplary iris image according to an embodiment of the invention, where solid lines 15 (e.g., shown in blue) indicate a presumptive segmentation contour S, points 17 (e.g., shown in green) inside the presumptive segmentation contour S are eroded points s_{ε}⁻, and points 19 (e.g., shown in green) outside the presumptive segmentation contour S are dilated points s_{ε}⁺.

As shown in FIG. 1, a preset number of points are sampled on the inner boundary and the outer boundary. A contour point S on a presumptive segmentation contour is parameterized as a triple (xc, yc, r), which denotes the coordinate of its circle center and radius. A dilated version of the contour point S (sample point on the outer boundary) is denoted as s_{ε}⁺ parameterized as a triple(x_{c}, y_{c}, r+c), and an eroded version of the contour point S (sample point on the inner boundary) is denoted as s_{ε}⁻ parameterized as a triple (x_{c}, y_{c}, r−ε). Then, every presumptive contour point S has its corresponding points s_{ε}⁺ and s_{ε}⁻. Further, the point S may be represented as (x_{c}+r cosθ, y_{c}+r sin θ), and thus the corresponding dilated point s_{ε}⁺ may be represented as (x_{c}+(r+ε)cos θ, y_{c}+(r+ε) sin θ), and the corresponding eroded point s_{ε}⁻ may be represented as (x_{c}+(r−ε) cos θ, y_{c}+(r−ε) sin θ).

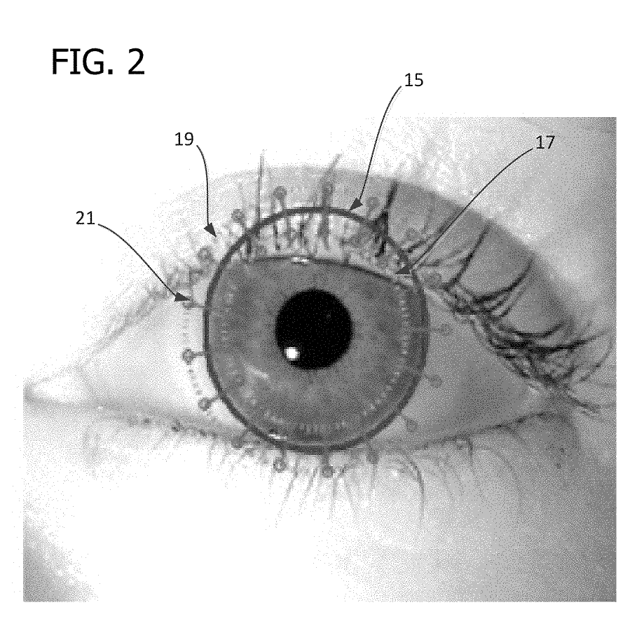

FIG. 2 shows a schematic diagram illustrating the accumulation

$$difference k ( = \frac{{\sum }_{i = 1}^{N} ‖ {p}_{i}^{+} - {p}_{i}^{-} ‖}{N} ) .$$

Referring to FIG. 2, assume N pairs, indicated generally by reference character 21, of corresponding sample points s_{ε}⁺ and s_{ε}⁻ (denoted as (pᵢ⁺, pᵢ⁻), i ∈ [1, N]) are collected, the accumulated differences of the N pairs of sample points can be described as:

$$k = \frac{{\sum }_{i = 1}^{N} ‖ {p}_{i}^{+} - {p}_{i}^{-} ‖}{N} .$$

In that case, however, when a sampling angle θ is within the range of 30° to 150° and the range of 210° to 330°, the accumulated differences may be seriously affected due to the possible existence of the occlusion artifact such as eyelashes and upper/lower eyelids. In order to stabilize the computed accumulative difference, values of the sampling angle θ are restricted within the range of −20′ to 20′ and the range of 160° to 200°, and thus the corresponding dilated point s_{ε}⁺ may be adjusted as (x_{c}+r cos θ+(−1)^{p}ε, y_{c}+r sin θ), and the corresponding eroded point s_{ε}⁻ may be adjusted as (x_{c}+r cos θ+(−1)^{p+1}ε, y_{c}+r sin θ), where P=0 (0°≦θ<90°; 270°≦θ<360°) or P=1 (90°≦θ<270°). Without the loss of generality, the inner pupil boundary usually has two characteristics:
(a) Sometimes the contrast between pupil and iris is relatively small compared to the outer boundary; and
(b) The boundary is visible most of the time, and the inner pupil boundary is not liable to be occluded by eyelashes or eyelids.

Therefore, to compensate the phenomenon described in (a), the smoothed image may be binarized to enhance the difference of pixel intensity between the pupil region and the iris region before caculations are performed. To compensate the phenomenon mentioned in (b), we may set the sampling angle as θ=θₘ+k*θ_{Δ}, where θ_{Δ}=5°, θₘ∈{0°, 180°}, and k is an integer ranged from from 0 to 4 or from 0 to −4. For the outer iris boundaries, the feature of “distance to the center of the circle” is added and serving as the 10-th feature, except for the local texture captured by the 3×3 window. The 10-th feature may reduce the errors in the clustering result due to the local similarity between the pupil and cast shadows. In that case, values of the sampling angle are determined according to the following equation: θ=θₘ+k*θ_{Δ}, where θ_{Δ}=5°, θₘ=0° or 180°, and k is an integer ranged from 0 to 4 or from 0 to −4.

According to the above embodiment, the judgment mechanism is realized by a segmentation algorithm that calculates characteristic parameters of an image to determine the correctness of iris segmentation without human intervention. This improves recognition speed, minimizes amount of manual labor, and enhances recognition stability and reliability.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A method for validating segmentation of an object, comprising:
processing an image of the object to enhance contour characteristics of the object and reduce external interference;
setting a presumptive segmentation contour for the object according to a characteristic equation and setting an inner boundary and an outer boundary for the presumptive segmentation contour to define an area, wherein the inner boundary is formed by inwardly shifting points on the presumptive segmentation contour for a preset distance according to the characteristic equation, and the outer boundary is formed by outwardly shifting points on the presumptive segmentation contour for a preset distance according to the characteristic equation; and
setting a predetermined number of pairs of points and accumulating differences of the pairs of points to judge the correctness of segmentation of the object, wherein each pair of points comprise a first sample point on the outer boundary and a second sample point on the inner boundary.

2. The method as claimed in claim 1, wherein the processing is performed using K-means algorithm, according to the K-means algorithm, the image is defined as K number of clusters, positions of K points μ₁₋μ_{K} in a parameter space are randomly initialized to form the K number of clusters, each sample of N units of samples X1-XN is assigned to a cluster whose center is derived by following equation:
arg min_{1≦i≦k}||xⱼ−μᵢ||², xⱼ ∈ {x₁, . . . , x_{N}}, all centers of clusters are updated using the following equation:
$${μ}_{i} = \frac{{\sum }_{X ∈ si} X}{\vert Sk \vert} , 1 \leq i \leq k ,$$
calculations using the above two equations are iterated until all centers of clusters become stable, and the stable state is determined according to the following equation:
$$\frac{{\sum }_{1 \leq i \leq k} {\sum }_{{x}_{j} ∈ {s}_{i}} {‖ {x}_{j} - {μ}_{i} ‖}^{2}}{\vert n \vert} < ɛ ,$$
where ε is a given threshold.

3. The method as claimed in claim 2, wherein data produced by the K-means algorithm is converted by principal component analysis (PCA) into a set of linearly uncorrelated variables, during the conversion, a local 3×3 window around 10 cluster centers is extracted as training data to construct a PCA subspace, the PCA subspace includes 9 eigenvectors that are sorted with importance thereof and placed as column vectors V, the original cluster centers are projected to the PCA subspace using the following equation:
$${μ}_{i}^{′} = {V}^{T} ( {μ}_{i} - \frac{{\sum }_{j = 1}^{k} {μ}_{j}}{k} ) , 1 \leq i \leq k ,$$
where V^{T} denotes the transpose of the column vectors V, and each data point is projected into the same coordinate system by the following equation:
$${x}_{i}^{′} = {V}^{T} ( {x}_{i} - \frac{{\sum }_{j = 1}^{k} {μ}_{j}}{k} ) , {x}_{i} ∈ \{ {x}_{1} , … , {x}_{n} \} ,$$
where xi is a pixel value of the local 3×3 window in the image, all values of xi′ are grouped into a new cluster whose center is derived by the following equation:
arg min_{1≦i≦k}||xᵢ′−μᵢ′||², xⱼ∈{x₁′, . . . , xₙ′},
and each pixel intensity value is represented as a value in the range of {0, 255} to generate a smooth image.

4. The method as claimed in claim 1, wherein a contour point on the presumptive segmentation contour is parameterized as (xc, yc, r), the first sample point on the outer boundary is parameterized as (xc, yc, r+ε), the second sample point on the inner boundary is parameterized as (xc, yc, r−ε), each contour point corresponds to a first sample point and a second sample point, the contour point is further represented as (x_{c}+r cos θ, y_{c}+r sin θ), the first sample point is further represented as (x_{c}+(r+ε) cos θ, y_{c}+(r+ε) sin θ), the second sample point is further represented as (x_{c}+(r−ε) cos θ, y_{c}+(r−ε) sin θ), and, assume N pairs of sample points denoted as (pᵢ⁺, pᵢ⁻), i ∈ [1, N]) are collected, the accumulated differences of the N pairs of sample points are described as:
$$k = \frac{{\sum }_{i = 1}^{N} ‖ {p}_{i}^{+} - {p}_{i}^{-} ‖}{N} .$$

5. The method as claimed in claim 4, wherein the presumptive segmentation contour has a substantially circular shape and comprises a pupil inner circle and an iris outer circle.

6. The method as claimed in claim 5, wherein a sampling angle θ is restricted within a range of −20° to 20° and the range of −160° to 200°, the first sample point is thus adjusted as (x_{c}+r cos θ+(−1)^{p}ε, y_{c}+r sin θ), and the second sample point is thus adjusted as (x_{c}+r cos θ+(−1)^{p+1}ε, y_{c}+r sin θ).

7. The method as claimed in claim 6, wherein, for the pupil inner circle, the sampling angle θ satisfies the condition:
θ=θₘ+k*θ_{Δ}, where θ_{Δ}=5°, θₘ ∈ {0°, 180°}, and k is an integer ranged from from 0 to 4 or from 0 to −4.

8. The method as claimed in claim 6, wherein, for the iris outer circle, the sampling angle θ satisfies the condition:
θ=θₘ+k*θ_{Δ}, where θ_{Δ}=5°, θₘ=0° or 180°, and k is an integer ranged from 0 to 4 or from 0 to −4.

9. A non-transitory computer-readable medium with instructions stored thereon that, when executed by a processor, perform a method comprising:
processing an image of the object to enhance contour characteristics of the object and reduce external interference;
setting a presumptive segmentation contour for the object according to a characteristic equation and setting an inner boundary and an outer boundary for the presumptive segmentation contour to define an area, wherein the inner boundary is formed by inwardly shifting points on the presumptive segmentation contour for a preset distance according to the characteristic equation, and the outer boundary is formed by outwardly shifting points on the presumptive segmentation contour for a preset distance according to the characteristic equation; and
setting a predetermined number of pairs of points and accumulating differences of the pairs of points to judge the correctness of segmentation of the object, wherein each pair of points comprise a first sample point on the outer boundary and a second sample point on the inner boundary.

10. The non-transitory computer-readable medium as claimed in claim 9, wherein the processing is performed using K-means algorithm, according to the K-means algorithm, the image is defined as K number of clusters, positions of K points μ₁₋μ_{K} in a parameter space are randomly initialized to form the K number of clusters, each sample of N units of samples X1-XN is assigned to a cluster whose center is derived by following equation:
arg min_{1≦i≦k}||xⱼ−μᵢ||², xⱼ ∈ {x₁, . . . , x_{N}}, all centers of clusters are updated using the following equation:
$${μ}_{i}^{′} = \frac{{\sum }_{X ∈ si} X}{\vert Sk \vert} , 1 \leq i \leq k ,$$
calculations using the above two equations are iterated until all centers of clusters become stable, and the stable state is determined according to the following equation:
$$\frac{{\sum }_{1 \leq i \leq k} {\sum }_{{x}_{j} ∈ {s}_{i}} {‖ {x}_{j} - {μ}_{i} ‖}^{2}}{\vert n \vert} < ɛ ,$$
where ε is a given threshold.

11. The non-transitory computer-readable medium as claimed in claim 10, wherein data produced by the K-means algorithm is converted by principal component analysis (PCA) into a set of linearly uncorrelated variables, during the conversion, a local 3×3 window around 10 cluster centers is extracted as training data to construct a PCA subspace, the PCA subspace includes 9 eigenvectors that are sorted with importance thereof and placed as column vectors V, the original cluster centers are projected to the PCA subspace using the following equation:
$${μ}_{i}^{′} = {V}^{T} ( {μ}_{i} - \frac{{\sum }_{j = 1}^{k} {μ}_{j}}{k} ) , 1 \leq i \leq k ,$$
where V^{T} denotes the transpose of the column vectors V, and each data point is projected into the same coordinate system by the following equation:
$${x}_{i}^{′} = {V}^{T} ( {x}_{i} - \frac{{\sum }_{j = 1}^{k} {μ}_{j}}{k} ) , {x}_{i} ∈ \{ {x}_{1} , … , {x}_{n} \} ,$$
where xi is a pixel value of the local 3×3 window in the image, all values of xi′ are grouped into a new cluster whose center is derived by the following equation:
arg min_{1≦i≦k}||xᵢ′−μᵢ′||²,xⱼ∈{x₁′, . . . , xₙ′},
and each pixel intensity value is represented as a value in the range of {0, 255} to generate a smooth image.

12. The non-transitory computer-readable medium as claimed in claim 9, wherein a contour point on the presumptive segmentation contour is parameterized as (xc, yc, r), the first sample point on the outer boundary is parameterized as (xc, yc, r+ε), the second sample point on the inner boundary is parameterized as (xc, yc, r−ε), each contour point corresponds to a first sample point and a second sample point, the contour point is further represented as (x_{c}+r cos θ, y_{c}+r sin θ), the first sample point is further represented as (x_{c}+(r+ε) cos θ, y_{c}+(r+ε) sin θ), the second sample point is further represented as (x_{c}+(r−ε) cos θ, y_{c}+(r−ε) sin θ), and, assume N pairs of sample points denoted as (pᵢ⁺, pᵢ⁻), i ∈ [1, N]) are collected, the accumulated differences of the N pairs of sample points are described as:
$$k = \frac{{\sum }_{i = 1}^{N} ‖ {p}_{i}^{+} - {p}_{i}^{-} ‖}{N} .$$

13. The non-transitory computer-readable medium as claimed in claim 12, wherein the presumptive segmentation contour has a substantially circular shape and comprises a pupil inner circle and an iris outer circle.

14. The non-transitory computer-readable medium as claimed in claim 13, wherein a sampling angle θ is restricted within a range of −20° to 20° and the range of −160° to 200°, the first sample point is thus adjusted as (x_{c}+r cos θ+(−1)^{p}ε, y_{c}+r sin θ), and the second sample point is thus adjusted as (x_{c}+r cos θ+(−1)^{p+1}_{ε}, y_{c}+r sin θ).

15. The non-transitory computer-readable medium as claimed in claim 14, wherein, for the pupil inner circle, the sampling angle θ satisfies the condition:
θ=θₘ+k*θ_{Δ}, where θ_{Δ}=5°, θₘ=0° or 180 °, and k is an integer ranged from from 0 to 4 or from 0 to −4.

16. The non-transitory computer-readable medium as claimed in claim 14, wherein, for the iris outer circle, the sampling angle θ satisfies the condition:
θ=θₘ+k*θ_{Δ}, where θ_{Δ}=5°, θₘ=0° or 180 °, and k is an integer ranged from 0 to 4 or from 0 to −4.
